(19) United States
(12) Patent Application Publication
(10) Pub. No.: US 2009/0120143 A1
(43) Pub. Date: May 14, 2009

(54) ROTATING MACHINE INCLUDING A SELF-LOCKING BALANCING MEMBER

(75) Inventors: Eric Steven Buskirk, Guilderland, NY (US); William Earl Fish, Amsterdam, NY (US); Karsten Johannes Tessarzik, Altamont, NY (US)

Correspondence Address: CANTOR COLBURN, LLP, 20 Church Street, 22nd Floor, Hartford, CT, 06103, US

(73) Assignee: GENERAL ELECTRIC COMPANY, Schenectady, NY (US)

(21) Appl. No.: 11/937,074

(22) Filed: Nov. 8, 2007

(51) Int. Cl. G05G 5/00

(52) U.S. Cl. 70/174

(57) ABSTRACT

A rotating machine includes a stationary component, a rotating component that is moveable relative to the stationary component, and a balancing member detachably mounted to the rotating component. The balancing member includes a self-locking device that selectively engages the rotating component when in a locked position and disengages the rotating component, to permit removal of the balancing member, when in an unlocked position. In this manner, the self-locking device prevents the balancing component from becoming loose during operation of the rotating machine without requiring staking the balancing component to the rotating component.

### BACKGROUND OF THE INVENTION

The present invention pertains to the art of rotating machines and, more particularly, to a self-locking weight for balancing a rotating component of a rotating machine.

In the manufacture of rotating machines, such as turbomachines, final balancing of rotating components is an essential and important step. In addition to final balancing after manufacture, periodic re-balancing of the rotating component is necessary in order to ensure proper operation and long operational life. Balancing is typically achieved by adding or removing weights to the rotating component, e.g., rotor, to compensate for deviations in rotor straightness and components mounted to the rotor, such as buckets and covers, or to lower vibration levels at which the turbomachine is operating.

The weights are typically mounted in weight grooves or openings formed in the rotor. Weight grooves for turbomachines usually have a T-shaped or dovetail cross-section. The weight is positioned in the weight groove, moved to the proper angular position, and staked, peened or otherwise locked in place. Balance weight grooves that are intended for re-balancing during service are typically accessed through ports provided on a casing of the machine. Rebalance weights are fit into a balance groove and typically require a special installation tool or are of a screw plug type. In either case, the weights must be staked or peened in place to prevent loosening during operation of the turbomachine.

When the rotor is serviced, e.g., provided with new field windings, the weights are removed so that the rotor can be rebalanced. Removal of the weights requires grinding off the stake or peen. The stake cannot be ground off when the rotor is in place. Grinding the stake in place would introduce debris into the turbomachine which, if not completely removed, could cause damage. Thus, the rotor must be removed, transported to a balance facility, balanced, and returned to service. This process can take as long as 2-3 weeks and can add considerably to machine down time. A power plant, for example, can loose significant in revenue each day the turbomachine is out of service. In addition, there is a limited number of times that a stake can be removed and reformed. Each removal and reforming, i.e., unlock/lock cycle, results in material loss to the rotor. After several such cycles, the rotor requires removal so the weight groove can be enlarged allowing additional lock/unlock cycles.

### BRIEF DESCRIPTION OF THE INVENTION

In accordance with one aspect of the present invention, a rotating machine is provided. The rotating machine includes a stationary component and a rotating component that is moveable relative to the stationary component. The rotating component includes a balancing member receiving opening. The rotating machine also includes a balancing member that is detachably mounted to the rotating component at the balancing member receiving opening. The balancing member includes a self-locking device that selectively engages the rotating component when in a locked position and disengages the rotating component, to permit removal of the balancing member, when in an unlocked position. In this manner, the self-locking device prevents the balancing component from becoming loose during operation of the rotating machine without requiring slaking the balancing component to the rotating component.

In accordance with another aspect of the present invention, a method of balancing a rotating member of a rotating machine is provided. The method includes exposing a balancing member receiving portion of the rotating member, partially inserting a balancing member having a self-locking device into the balancing member receiving portion, and operating a lock member actuator of the self-locking device. Once the lock member actuator is operated, a locking member of the self-locking device is retracted into the balancing member. At this point, the balancing member is scaled in the balancing member receiving portion, the lock member actuator is disengaged and the lock member is extended into engagement with the rotating member to prevent the balancing member from becoming loose during operation of the rotating machine.

Based on the above, it should be appreciated that exemplary embodiments of the present invention provide a balancing member that can be installed on a rotating component of a rotating machine without requiring staking or peening. In addition, the exemplary embodiments illustrate a balancing member that can be easily removed without requiring disassembly of the rotating machine and removal of the rotary component. In this manner, the present invention shortens rotating machine down time thereby increasing operating efficiency and reducing operational and maintenance costs. In any event, additional objects, features and advantages of various aspects of exemplary embodiments of the present invention will become more readily apparent from the following detailed description when taken in conjunction with the drawings wherein like reference numerals refer to corresponding parts in the several views.

### BRIEF DESCRIPTION OF THE DRAWINGS

FIG. 1 is a partial cross-sectional view of a rotating machine having a rotary component including a self-locking balancing member constructed in accordance with an exemplary embodiment of the present invention;

FIG. 2 is a partial perspective view of the rotary component and self-locking balancing member of FIG. 1;

FIG. 3 is a cross-sectional side view of a self-locking balancing member of constructed in accordance with a first exemplary embodiment of the present invention shown in a locked configuration;

FIG. 4 is a cross-sectional side view of the self-locking balancing member of FIG. 4 shown in an unlocked configuration;

FIG. 5 is a lower perspective view of the self-locking balancing member of FIG. 3;

FIG. 6 is a cross-sectional side view of a self-locking balancing member constructed in accordance with a second exemplary embodiment of the present invention shown in a locked configuration;

FIG. 7 is a cross-sectional side view of a self-locking balancing member constructed in accordance with a third exemplary embodiment of the present invention shown in a locked configuration;

FIG. 8 is a cross-sectional side view of the self-locking balancing member of FIG. 7 shown in an unlocked configuration;

FIG. 9 is a partial cross-sectional view of a fan support in accordance with an exemplary embodiment of the present invention; and

FIG. 10 is a perspective view of a self-locking balancing member constructed in accordance with a fourth exemplary embodiment of the present invention.

### DETAILED DESCRIPTION OF THE INVENTION

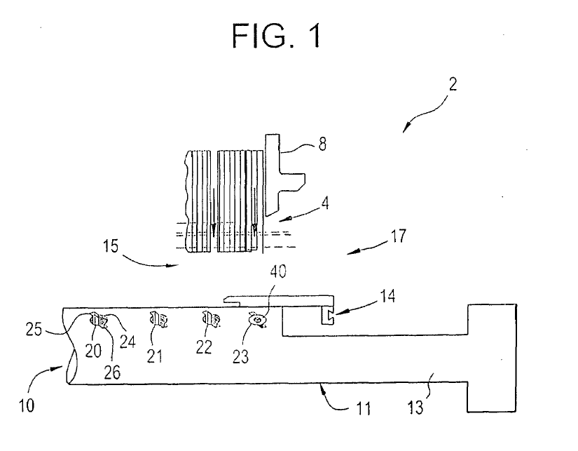

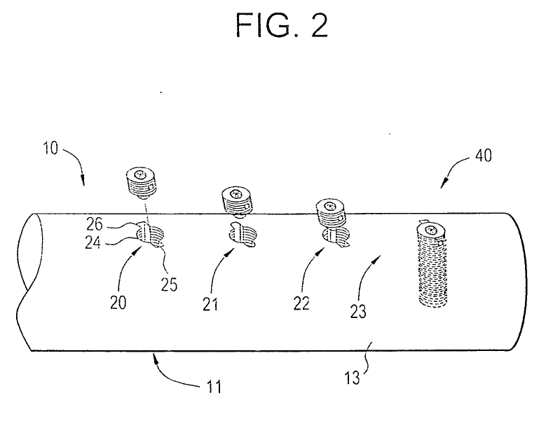

With Initial Reference to FIGS. 1-2, a rotary or rotating machine constructed in accordance with an exemplary embodiment of the present invention is illustrated as a turbomachine indicated generally at 2. Turbomachine 2 includes a stationary member or stator 4 having a plurality of slacked laminations indicated generally at 6 that are held in place by a flange 8. Turbomachine 2 further includes a rotating member or rotor 10. Rotor 10 includes a main body 11 having an outer surface 13. Rotor 10 is also shown to include a fan support 14 that provides mounting structure for a fan assembly (not shown) that generates cooling air flow. As shown, rotor 10 is spaced from stator 4 by an air gap 15. Access to air gap 15 is obtained through an entrance gap 17 located adjacent flange 8. Rotor 10 includes a plurality of balancing member receiving openings 20-23, each of which includes a plurality of internal threads 24 and lock member receivers 25 and 26, such as shown in connection with balancing member receiving opening 20. Of course, the number, location and shape of lock member receivers 25 and 26 can vary. As will be discussed more fully below, a weight balancing member 40 is mounted in one or more of the plurality of balancing member receiving openings 20-23 to provide a dynamic balance for rotor 10.

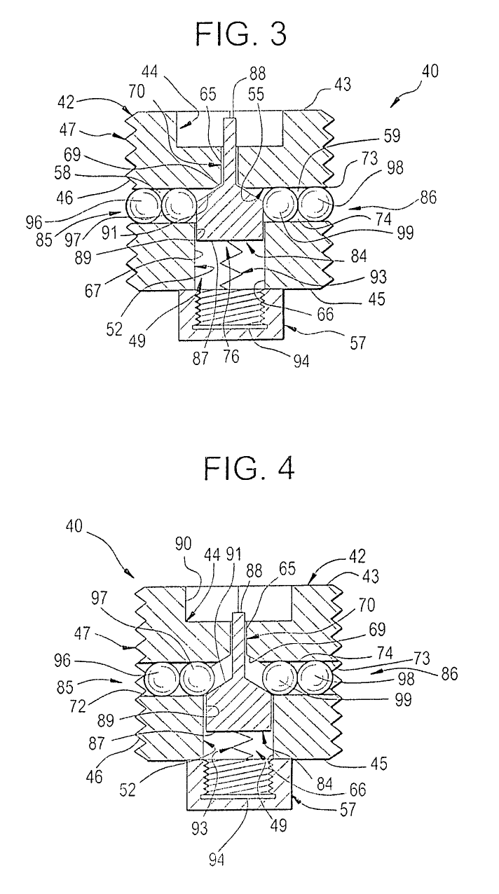

Reference will now be made to FIG. 3-5 in describing balancing member 40 constructed in accordance with a first exemplary embodiment of the present invention. Balancing member 40 includes a main body portion 42 having a first surface 43 provided with a recessed portion 44 shown in the form of a hexagon. First surface 43 extends to a second surface 45 through an outer wall 46. Outer wall 46 is provided with a plurality of threads 47 configured to engage with threads 24 provided in, for example, balancing member receiving opening 20. Main body portion 42 includes a locking device housing 49 having a lock member actuator portion 52 and a lock member portion 55 that are accessed by opening a removable cap member 57. As shown in FIG. 3, cap member 57 is detachably mounted to second surface 45 of main body portion 42.

Lock member actuator portion 52 includes a first end portion 65 that extends to a second end portion 66 through an intermediate portion 67. Intermediate portion 67 includes a tapered or angled wall segment 69 that establishes a narrow region 70 at first end portion 65. In a similar manner, lock member portion 55 includes a first end portion 72 that extends to a second end portion 73 through an intermediate portion 74. Lock member portion 55 actually bisects, lock member actuator portion 52. As will become more evident below, lock member portion 55 includes first and second opposing lock member sections 58 and 59 that extend from lock member actuator portion 52. In any event, first and second end portions 72 and 73 are peened, staked, or otherwise retained, e.g. by a c-clip, bolt, etc., to create a narrow diameter region (not separately labeled).

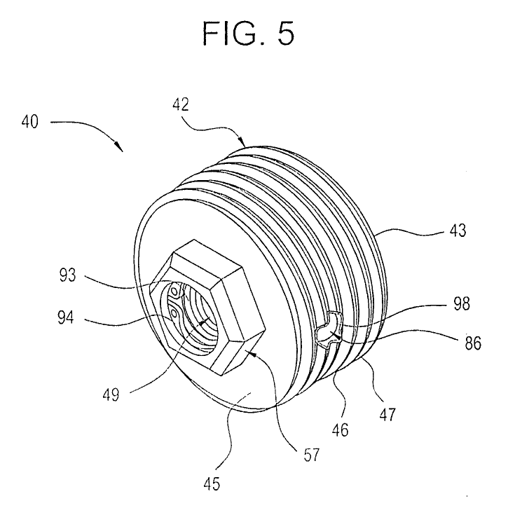

Balancing member 40 also includes a self-locking device 76 including a lock member actuator 84 and, in the exemplary embodiment shown, a pair of lock members 85 and 86. Lock member actuator 84 is positioned within lock member actuator portion 52 and includes a first end section 87 that extends to a second end section 88 through an intermediate section 89. Intermediate section 89 includes a tapered section 91 that corresponds to tapered wall segment 69 of lock member actuator portion 52. First end section 88 extends through narrow region 70 and projects into receded portion 44. In accordance with the exemplary embodiment shown, lock member actuator 84 is selectively shiftable between a first or locked position, such as illustrated in FIG. 3, and a second or unlocked position, such as shown in FIG. 4 as will be discussed more fully below. In any event, a spring 93 biases lock member actuator 84 in the first or locked position. Spring 93 is held in place by a locking clip 94 accessed through cap member 57 as shown in FIG. 5. Locking clip 94 enables spring 93 to be conical in shape to reduce an overall height of balancing member 40. In addition, to spring 93 biasing lock member actuator in the locked position, centrifugal force generated by rotor 10 further acts to lock balancing member 40 in place.

When in the locked position lock member actuator 84 urges lock members 85 and 86 shown, in the form of first and second pairs of locking spheres or ball bearings 96, 97 and 98, 99, out from main body portion 42. When installed in one of the plurality of balancing member receiving openings 20-23, into lock member receiver 25. That is, lock member 85 extends beyond outer wall 46 and into lock member receiver 25 to prevent balancing member 40 from becoming loose during operation of a turbomachine 2. In order to insert balancing member 40 into balancing member receiving opening 20, a tool (not shown) is inserted into recessed portion 44 to depress first end section 87 of lock member actuator 84. As first end a section 88 is depressed into recessed portion 44, lock member actuator 84 shifts within lock member actuator portion 52 against the force provided by spring 93. As lock member actuator 84 travels within lock member actuator housing 49, ball bearings 96 and 98 move along tapered section 91. As tapered section 91 is shifted into position, lock members 85 and 86 retract into to main body portion 42. At this point, balancing member 40 is threaded into balancing member receiving opening 20. Once in position, lock member portion 55 is aligned with lock member receiver 25 and 26, the tool is removed, and lust end portion 88 is released. Once released, spring 93 urges lock member actuator 84 to the locked position causing tapered section 91 to urge lock members 85 and 86 into lock member receiver 25 and 26. In this manner, locking device 76 is selectively resiliently biased to engage rotor 10 when in a locked position and disengage from rotor 10 to permit removal and or installation of balancing member 40 when in an unlocked position Removal of balancing member 40 is achieved by reversing the above described operation.

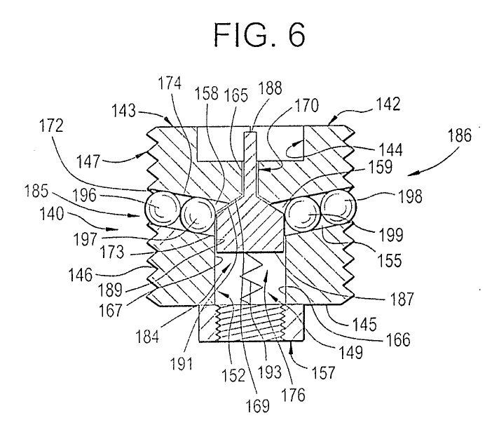

Reference will now be made to FIG. 6 in describing a balancing member 140 constructed in accordance with a second exemplary embodiment of the present invention. Balancing member 140 includes a main body portion 142 having a first surface 143 provided with a recessed portion 144. First surface 143 extends to a second surface 145 through an outer wall 146. As shown, outer wall 146 includes a plurality of threads, indicated generally at 147, that correspond to threads 24 in each of the plurality of balancing member receiving openings 20-23. In a manner similar to that described above, balancing member 140 includes a locking device housing 149 that includes a lock member actuator portion 152 and a lock member portion 155 that are accessed via a detachably mounted cap member 157. As will become more evident below, lock member portion 155 includes first and second opposing lock member sections 158 and 159 that extend at an angle from lock member actuator portion 152 towards first surface 143.

In a manner also similar to that described above, lock member actuator portion 152 includes a first end portion 165 that extends to a second end portion 166 through an intermediate portion 167. In manner similar to that described above, intermediate portion 167 includes a tapered or angled wall segment 169 that provides a transition to a narrow region 170 at first end portion 165. Lock member sections 158 and 159 are identical such that a description will follow with respect to lock member section 158 with an understanding that lock member section 159 is similarly formed. As shown, lock member section 158 includes a first end portion 172 that extends to a second end portion 173 through an intermediate portion 174. First end portion 172 is staked, peened or otherwise locked to establish a narrow diameter portion at outer wall 146. As noted above, lock member section 158 extends at an angle from lock member actuator portion 152 towards first surface 143.

Balancing member 140 is also shown to include self-locking device 176 including a lock member actuator 184 and first and second lock members 185 and 186. Lock member actuator 184 is positioned within lock member actuator portion 152 and includes a first end section 187 that extends to a second end section 188 through an intermediate section 189. Intermediate section 189 includes a tapered section 191 that corresponds to tapered wall segment 169 of lock member actuator portion 152. First end section 188 extends through narrow region 170 and projects into receded portion 144. A spring 193 biases lock member actuator 84 in the first or locked position. Spring 193 is held in place by a locking clip (not shown).

As shown, lock members 185 and 186 include first and second pairs of locking spheres or ball bearings 196, 197 and 198, 199. Lock member actuator 184 is positioned within lock member actuator portion 152 and is selectively shiftable between a first or locked position and a second or unlocked position. When in the unlocked position, the angle of lock member sections 158 and 159 facilitates the transition of ball bearings 196-199 between corresponding locked and unlocked configurations. That is, when lock member actuator 184 is in the unlocked position, ball bearings 196-199 roll along respective lock member sections 158 and 159 and retract into main body portion 142. To facilitate insertion and removal from rotor 10 in a manner similar to that described above.

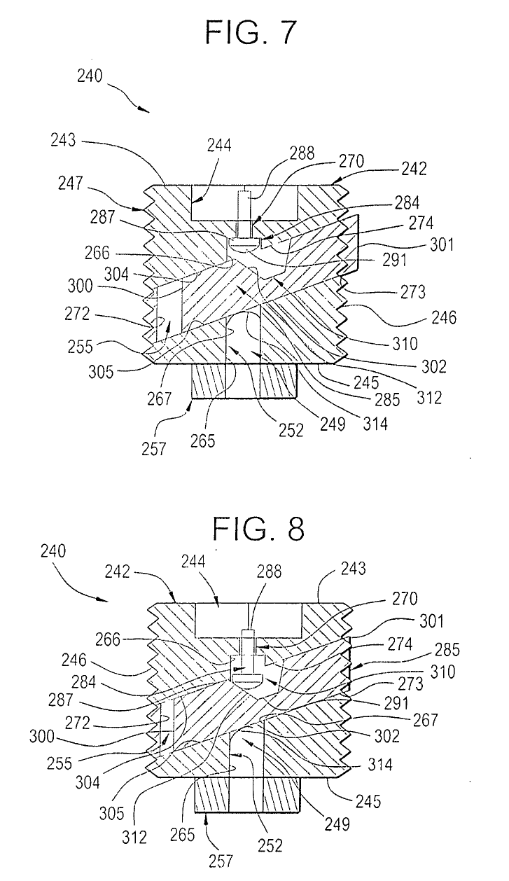

Reference will now be made into FIGS. 7-8 in describing a balancing member 240 constructed in accordance with a third exemplary embodiment of the present invention. Balancing member 240 includes a main body portion and 242 having a first surface 243 provided with a recessed portion 244. First surface 243 extends to a second surface 245 through an outer wall 246. Outer wall 246 includes a plurality of threads, indicated generally at 247, that are configured to engage with threads 24 provided in each the plurality of balancing member receiving openings 20-23. In a manner similar to that described above, balancing member 240 includes a locking device housing 249 including a lock member actuator portion 252 and a lock member portion 255 that are accessed via a detachably mounted cap member 257.

Lock member actuator portion 252 includes a first end portion 265 that extends to a second end portion 266 through an intermediate portion 267. First end portion 265 transitions to a narrow region 270 that leads into recessed portion 244. Lock member portion 255 includes a first end portion 272 that extends to a second end portion 273 through an intermediate portion 274. Lock member portion 255 actually bisects, at an angle, lock member actuator portion 252. In any event, balancing member 240 also includes a self-locking device 276 having a lock member actuator 284 and a lock member 285. Lock member actuator 284 is shiftably mounted within lock member actuator portion 252. As shown, lock member actuator 284 includes a first end portion 287 that extends to a second end portion 288. First end portion 287 includes a rounded member 291 that is designed to engage with lock member 285 as will be detailed below.

In accordance with the embodiment shown, lock member 285 includes a first end 300 that extends to a second end 301 through an intermediate portion 302 including first and second opposing surfaces 304 and 305. First surface 304 is provided with a lock member actuator receiver 310 having an angled surface 312 configured to inter-engage with rounded member 291 when lock member actuator 284 is shifted to the unlocked position such as shown in FIG. 8. More specifically, in the locked position, such as illustrated in FIG. 7, a spring 314 biases lock member 298 outward so as to extend through outer wall 246. In addition, centrifugal force generated by rotor 10 further locks lock member 285 in place. When lock member actuator 285 is shifted to the unlocked position (see FIG. 8) such as by inserting a tool (not shown) into recessed portion 244, rounded member 291 moves into contact with angled surface 312 of lock member actuator receiver 310. Further shifting of lock member actuator 284 moves lock member 285 into main body portion 242. At this point, balancing member 242 can be inserted into or removed from for example, rotor 10.

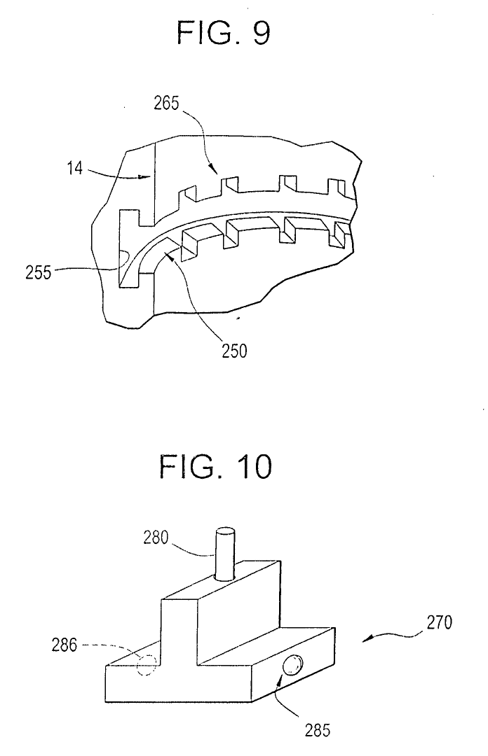

Reference will now be made to FIGS. 9 and 10 in describing another exemplary embodiment of the present invention. In addition to providing balancing member assembly receiving opening 20-23 on rotor 10, rotating machine 2 also includes a balancing member receiving section 350 provided on fan support 14. Balancing member receiving section 350 is defined by a slot 355 that extends about an inner circumference of fan support 14. Slot 355 includes a plurality of notches, one of which is indicated at 365. Notches 365 define discrete balancing positions fan support 14.

As shown in FIG. 10, a self-locking balancing member 370 having a generally T-shaped configuration includes a self-locking device 373 having a lock member actuator 380 that is selectively depressed to release a pair of opposing locking members 385 and 386. With this arrangement, lock member actuator 380 is depressed and self-locking balancing member 370 is inserted into slot 355 and moved to a desired balancing position. Once in the desired balancing position, lock member actuator 380 is released allowing locking members 385 and 386 to engage corresponding notches 365 to lock balancing member 370 to support 14. Of course, it should be understood that the slot 355 could includes a dove tail configuration, such as shown in FIG. 1, with balancing member 370 including complimentary structure.

At this point, it should be appreciated that the present invention provides a balancing member that can be installed on a rotating member of a turbomachine without requiring slaking or peening. In addition, the exemplary embodiments illustrate a balancing member that can be easily removed without requiring disassembly of the turbomachine and removal of the rotor. In this manner, the present invention shortens turbomachine down time thereby increasing operating efficiency and reducing operational and maintenance costs. Furthermore, it should be understood that while shown in pairs, single lock members could also be employed. Also the cap member can be made integral with the main body while still providing access to the clip to allow removal and installation of the spring.

In general, this written description uses examples to disclose the invention, including the best mode, and also to enable any person skilled in the art to practice the invention, including making and using any devices or systems and performing any incorporated methods. The patentable scope of the invention is defined by the claims, and may be includes other examples that occur to those skilled in the art. Such other examples are intended to be within the scope of the present invention if they have structural elements that do not differ from the literal language of the claims, or if they include equivalent structural elements with insubstantial differences from the literal language of the claims.

1. A rotating machine comprising:
a stationary component:
a rotating component moveable relative to the stationary component, the rotating component including a balancing member receiving opening; and
a balancing member detachably mounted to the rotating component at the balancing member receiving opening, the balancing member including a self-locking device that is selectively resiliently biased to engage the rotating component when in a locked position and disengage from the rotating component to permit removal and installation of the balancing member when in an unlocked position, the locking device preventing loosening of the balancing component during operation of the rotating machine.

2. The rotating machine according to claim 1, wherein the self-locking device includes a lock member and a lock member actuator.

3. The rotating machine according to claim 2, wherein the balancing member includes a main body portion having an upper surface, a lower surface and an outer wall portion that collectively define a locking device housing, the lock member being selectively shifted between the locked position, wherein the locking member extends from the outer wall, and the unlocked position, wherein the lock member is retracted into the main body portion.

4. The rotating machine according to claim 3, wherein the lock member actuator is positioned, at least in part, in the locking device housing, the lock member actuator being selectively shiftable between a first position, wherein the lock member actuator maintains the lock member in a locked position, and a second position, wherein the lock member actuator permits the lock member to shift to an unlocked position.

5. The rotating machine according to claim 4, wherein the lock member actuator includes a tapered portion, the tapered portion engaging the lock member to facilitate shifting between the locked and unlocked positions.

6. The rotating machine according to claim 3, wherein the locking device includes a spring mounted in the locking device housing, the spring biasing the lock member actuator in the locked position.

7. The rotating machine according to claim 3, wherein the locking device housing includes a lock member actuator portion and a lock member portion, the lock member portion extending from the lock member portion at an angle.

8. The rotating machine according to claim 2, wherein the lock member is a locking sphere.

9. The rotating machine according to claim 2, wherein the lock member is a locking bar.

10. The rotating machine according to claim 9, wherein the locking bar includes an lock member actuator receiving portion, the lock member actuator engaging the lock member actuator receiving portion to shift the lock member between the locked and unlocked positions.

11. The rotating machine according to claim 1, further comprising: a fan support mounted to the rotor, the fan support including a balancing member assembly receiving section in the form of a slot having a plurality of notches that define a corresponding plurality of discrete balancing positions.

12. The rotating machine according to claim 11, wherein the balancing member includes a T-shaped cross-section configured to engage into the slot of the fan support, with the self-locking device selectively engaging one of the plurality of notches to secure the balancing member at one of the plurality of discrete balancing positions.

13. The relating machine according to claim 1, wherein the rotating machine is a turbomachine.

14. A method of balancing a rotating member of a rotating machine comprising:
exposing a balancing member receiving portion of the rotating member;
partially inserting a balancing member having a self-locking device into the balancing member receiving portion;
operating a lock member actuator of the self-locking device;
retracting a locking member of the self-locking device into the balancing member;
seating the balancing member in the balancing member receiving portion;
disengaging the lock member actuator; and
extending the lock member into engagement with the rotating member to prevent the balancing member from becoming loose during operation of the rotating machine.

15. The method of claim 14, wherein operating the lock member actuation includes shifting the lock member actuator from a first position, wherein the lock member is in a locked position to a second position, wherein the lock member is retracts into the balancing member.

16. The method of claim 15, further comprising: spring biasing the lock member actuator in the first position.

17. The method of claim 14, wherein operating the lock member actuator includes shifting a tapered portion of the lock member actuator into contact with the lock member.

18. The method of claim 14, wherein seating the balancing member into the balancing member receiving portion includes screwing the balancing member into a threaded opening provide on the rotating member.

19. The method of claim 14, wherein extending the lock member into engagement with the rotating member includes moving a ball bearing into engagement with a lock member receiver provided on the balancing member receiving portion.

20. The method of claim 14, wherein extending the lock member into engagement with the rotating member includes moving a locking bar into engagement with a lock member receiver provided on the balancing member receiving portion.
